(19) United States
(12) Patent Application Publication
(10) Pub. No.: US 2025/0135483 A1
(43) Pub. Date: May 1, 2025

(54) PAINTING DEVICE

(71) Applicant: ABB SCHWEIZ AG, Baden (CH)

(72) Inventor: Kuniharu Yamauchi, Tokyo (JP)

(21) Appl. No.: 18/892,405

(22) Filed: Sep. 22, 2024

(30) Foreign Application Priority Data
Oct. 31, 2023 (JP) 2023-186330

(51) Int. Cl. B05B 15/55

(52) U.S. Cl. CPC B05B 15/55

(57) ABSTRACT

A painting device, which is equipped with a paint head that ejects paint. The painting device includes a supply path that supplies paint to a coating head, a return path that returns the paint not ejected from the paint head to an upstream side of the supply path, and a paint head that is equipped with a paint circulation path 41 that is divided into a plurality of sections. The plurality of sections are individually cleaned in order from the upstream side of the paint circulation path, and after washing is completed and the next section is being washed, the paint is sequentially filled into the upstream section.

### TECHNICAL FIELD

The present invention relates to a painting device.

### BACKGROUND TECHNOLOGY

A coating device that performs coating using a coating head having a plurality of nozzles. In a painting device, the paint color may be switched midway through painting to different colors using the same painting device. When changing the paint color, a cleaning liquid is flowed through the paint supply path to clean the supply path in order to prevent paints of different colors from mixing.

In order to prevent separation and agglomeration of the paint, the painting device has a paint circulation path that supplies the paint to the paint head, collects the paint that is not discharged from the paint head, and supplies the paint to the paint head again.

When cleaning the paint circulation path, the state of paint adhesion in the paint circulation path varies depending on the various components that make up the path, so it is difficult to sufficiently wash away the paint even if the paint circulation path is cleaned uniformly. In addition, when the cleaning liquid is caused to flow from the upstream side of the paint circulation path, the cleaning action of the cleaning liquid is less likely to be obtained downstream, resulting in a longer cleaning time.

Therefore, Patent Literature 1 discloses a painting device that divides a paint circulation path into multiple sections including a paint head and multiple circuit components arranged in the paint circulation path, and individually cleans each of the divided sections, thereby improving the cleanability of each component and downstream cleanability.

### PRIOR ART LITERATURE

### Patent Literature

[Patent Literature 1] Japanese Unexamined Patent Application Publication 2023-056828

### SUMMARY OF THE INVENTION

### Problem to be Solved by the Invention

However, in the coating device described in Patent Literature 1, the paint is refilled only after all of the divided sections of the paint circulation path have been cleaned, so there is a waiting time required from the end of cleaning to refilling all of the sections with paint, and this lengthens the cycle time of the entire painting device.

The present invention has been made in consideration of the above circumstances, and aims to provide a painting device that can reduce the time required to refill with paint after cleaning when the paint circulation path is divided and cleaned.

### Means for Solving the Problems

The painting device according to one aspect of the present invention is equipped with a paint head that ejects paint, and is composed of a supply path that supplies paint to the paint head, a return path that returns the paint not ejected from the paint head to the upstream side of the supply path, and a paint head that is equipped with a paint circulation path that is divided into a plurality of sections, and the plurality of sections are individually cleaned in order from the upstream side of the paint circulation path, and when washing is completed and the next section is being washed, the paint is sequentially filled into the upstream section where washing has been completed.

In addition, in the above-mentioned invention, it is preferable that the paint circulation path connecting the head section including the paint head and the upstream section adjacent to the upstream side of the head section is further provided with an inlet side switching valve with a switching position for filling the upstream section with paint while flowing cleaning liquid for cleaning into the head section.

In addition, in the above-mentioned invention, it is preferable to further include an outlet side switching valve interposed in the paint circulation path connecting the head section and the downstream section adjacent to the downstream side of the head section, and having a switching position for filling the downstream section with paint while flowing cleaning liquid for cleaning into the head section.

Furthermore, in the above-mentioned invention, it is preferable that the device further includes an upstream switching valve interposed in the supply path upstream of the inlet switching valve, a downstream switching valve interposed in the return path downstream of the outlet switching valve, and a bypass path connecting the upstream switching valve and the downstream switching valve, and during cleaning of the head section, the upstream switching valve and the downstream switching valve are switched so that the paint in the supply path flows into the return path via the bypass path and flows back from the downstream switching valve to the outlet switching valve.

In addition, in the above-mentioned invention, it is preferable to further provide a pump interposed in the return flow path for returning the paint in the return flow path to the upstream side of the supply path, and to reverse the rotation of the pump during cleaning of the head section to cause the paint to flow back from the downstream switching valve to the outlet switching valve.

### Effects of the Present Invention

According to the present invention, in a painting device that separates and cleans the paint circulation path, it is possible to reduce the time required for filling paint after cleaning.

### BRIEF DESCRIPTION OF DRAWINGS

FIG. 1 is a schematic configuration diagram illustrating a painting robot of a painting device according to this embodiment.

FIG. 2 is a circuit diagram showing a paint circulation path of the painting device according to this embodiment.

FIG. 3 is a flow chart showing the flow of a paint circulating path cleaning process and a paint refilling process of the painting device according to this embodiment.

### DETAILED DESCRIPTION OF THE EMBODIMENTS

Hereinafter, the painting device 10 according to the present embodiment will be described with reference to the drawings.

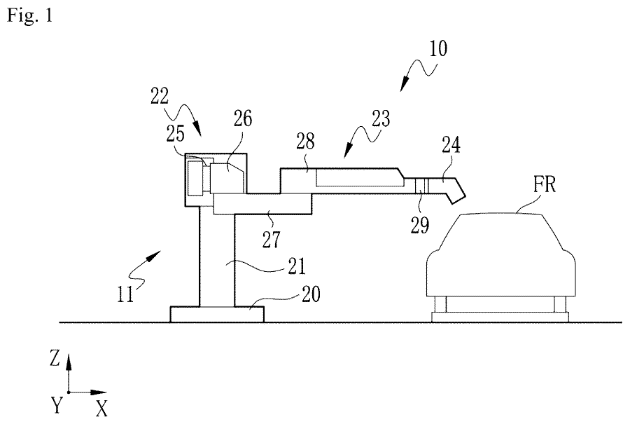

FIG. 1 is a schematic configuration diagram illustrating a painting robot 11 of the painting device 10 according to this embodiment. The painting robot 11 is disposed near a painting line in an automobile manufacturing plant, and paints the vehicle body FR that is transported along the painting line. In the present embodiment, the vehicle body FR of an automobile is exemplified as the object to be painted, but the object may be something other than the vehicle body FR of an automobile.

### [The Painting Robot]

The painting robot 11 paints the vehicle body FR that is transported from the upstream side of the painting line. In the painting process, painting may be performed on the vehicle body FR while the body is moving along the painting line, or painting may be performed by stopping the flow of the line at a predetermined position. The vehicle body FR that has been painted by the painting robot 11 is transported toward the downstream side of the painting line.

In the present embodiment, the painting robot 11 is exemplified as a device for painting the vehicle body FR, but the device does not have to be the painting robot 11 as long as it has a paint circulation path 41 described later. In addition, the painting robot 11 is exemplified as one in which the paint head unit 24 can rotate in directions centered on three axes, the X-axis, the Y-axis, and the Z-axis, but the paint head unit 24 may be one that rotates about one of the X-axis, the Y-axis, or the Z-axis, or one that rotates about two axes.

Painting is carried out for the purpose of forming a coating film on the surface of an object to be painted, thereby protecting the surface and providing a beautiful appearance. The painting process may involve simply painting with a paint of a specific color or with a specific function, or it may involve sequentially applying paints of multiple colors or paints with specific functions.

The painting robot 11 is exemplified as an articulated robot, but a SCARA robot may also be used as long as it is capable of painting. As shown in FIG. 1, the painting robot 11 includes a base 20, a leg 21, a rotation drive unit 22, a robot arm 23, and a paint head unit 24.

The base 20 is a fixing member that fixes the painting robot 11 to the floor surface of the painting line and supports the painting robot 11. The base 20 may be movable on the floor surface of the painting line.

The leg 21 has a lower portion fixed to the base 20 and an upper portion connected to a rotation drive unit 22, and is extended to a vertical height suitable for painting by the painting robot 11.

The rotation drive unit 22 is connected to the upper end of the leg unit 21 and has a rotation shaft unit 25 and a rotation arm 26. The rotation shaft unit 25 rotates the rotation arm 26 by a motor (not shown) about a direction parallel to the floor surface (the X-axis direction shown in FIG. 1). The rotation arm 26 rotates the robot arm 23 connected to the rotation arm 26 about a line (the Z-axis direction shown in FIG. 1) perpendicular to the rotation center of the rotation shaft unit 25.

The robot arm 23 has a first rotation arm 27 and a second rotation arm 28. The first rotation arm 27 has one end connected to the rotation arm 26 and the other end connected to the second rotation arm 28. The first rotation arm 27 rotates around the Z-axis direction shown in FIG. 1 by a motor (not shown) mounted on the rotation arm 26. The second rotation arm 28 has one end connected to the first rotation arm 27 and has a wrist unit 29, which will be described later, at the other end. The second rotation arm 28 is rotated by a motor (not shown) about the Z-axis direction shown in FIG. 1.

The paint head unit 24 is disposed at the very tip of the painting robot 11 and sprays paint onto the vehicle body FR of the automobile. The wrist unit 29 is held between the paint head unit 24 and the second rotation arm 28. The wrist unit 29 rotates the paint head unit 24 about at least one of the three axes (X-axis, Y-axis, and Z-axis) shown in FIG. 1.

The paint head unit 24 has an internal paint circulation path 41 for spraying paint from the paint head, and sprays paint at appropriate timing onto the vehicle body FR moving along the painting line.

### [Paint Circulation Path]

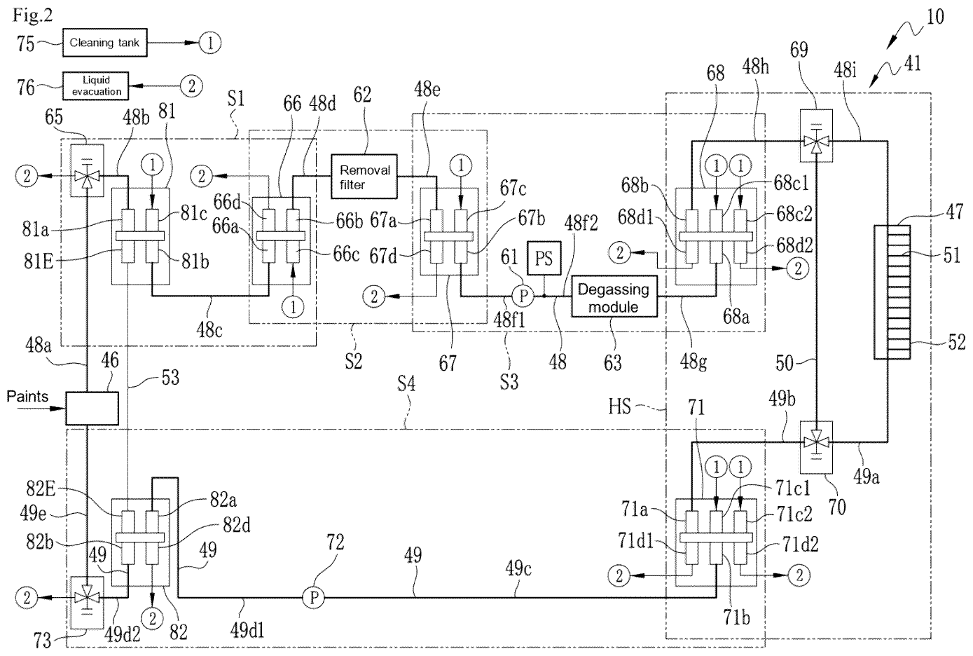

Next, the paint circulation path 41 of the painting device 10 will be described with reference to FIG. 2. FIG. 2 is a circuit diagram showing a paint circulation path 41 of the painting device 10 according to this embodiment.

The paint circulation path 41 includes a paint tank 46, a paint head 47, a supply path 48, a return path 49, and a first bypass path 50. The paint circulation path 41 is a circulation circuit that, when painting the vehicle body FR, supplies paint stored in a paint tank 46 to a paint head 47 via a supply path 48, and returns the paint not used in the paint head 47 to the paint tank 46 via a return flow path 49. In addition, when painting is not being performed on the vehicle body FR, the paint circulation path 41 also functions as a circulation circuit that returns the paint stored in the paint tank 46 from the supply path 48, via the first bypass flow path 50, and through the return flow path 49 to the paint tank 46.

In the supply path 48, the paint supply direction is such that the paint tank 46 side is referred to as the upstream side, and the paint head 47 side is referred to as the downstream side. In addition, in the return flow path 49, the paint head 47 side is referred to as the upstream side, and the paint tank 46 side is referred to as the downstream side.

The paint tank 46 stores the paint to be used when painting the vehicle body FR using the paint head 47. The paint tank 46 is disposed outside the painting robot 11 (for example, on the floor of the painting room) or on the robot arm 23, etc. The paint tank 46 is replenished with the paint from outside as required during the process of painting the vehicle body FR using the paint head 47.

The paint is a water-based paint or a solvent-based paint that uses pigments. Therefore, by circulating the paint within the paint circulation path 41, it is possible to prevent the pigment contained in the paint from separating or agglomerating within the paint circulation path 41, and also to reduce the viscosity of the paint.

The paint head 47 has a nozzle forming surface 52 on which a plurality of nozzles 51 are arranged, and the paint supplied via a supply path 48 is ejected from each of the plurality of nozzles 51 to form a paint film on the surface of the vehicle body FR. A nozzle row (not shown) is formed by a predetermined number of nozzles 51, and the nozzle row is arranged diagonally with respect to the scanning direction, which is the direction in which the paint head 47 moves, but the nozzle row may be arranged along the scanning direction or perpendicular to it. A detailed description of the configuration of the painting head 47 will be omitted.

### (Supply Path)

The supply path 48 is a flow path that supplies the paint stored in the paint tank 46 toward the paint head 47. The supply path 48 is divided into flow paths 48a, 48b, . . . , 48h, and 48i by a plurality of components interposed in the supply path 48. The paint in the supply path 48 is pumped by a first gear pump 61, which is disposed midway along the supply path 48 and will be described later.

The supply path 48 has, from the upstream side, a first three-way valve 65, a first switching valve 81 as an upstream side switching valve, a second switching valve 66, a removal filter 62, a third switching valve 67, a first gear pump 61, a pressure gauge PS, a degassing module 63, a fourth switching valve 68 as an inlet side switching valve, and a second three-way valve 69.

In the following description, the arrows connected to each switching valve from the cleaning tank 75 via the number “1” indicate flow paths through which cleaning liquid is supplied from the cleaning tank 75 to each switching valve. The arrows connected from each switching valve to the drain tank 76 via the number “2” indicate the flow paths through which the cleaning liquid and air flow from each switching valve to the drain tank.

The first three-way valve 65 is connected to the downstream end of the flow path 48a that extends downstream of the paint tank 46. The first three-way valve 65 can be switched between either a state in which it connects the flow path 48a to a flow path 48b extending downstream of the first three-way valve 65, or a state in which it connects the flow path 48b to a drain tank 76. When the paint head 47 is painting the vehicle body FR, the first three-way valve 65 is switched to a state in which the flow path 48a and the flow path 48b communicate with each other. As a result, the paint stored in the paint tank 46 flows through the supply path 48 by the operation of the first gear pump 61 described above.

Furthermore, when the flow path 48b is cleaned, the first three-way valve 65 is switched to a state in which the flow path 48b communicates with the drain tank 76. As a result, the cleaning liquid and air flowing through the flow path 48b in the direction opposite to the paint supply direction are discharged into the drain tank 76.

Here, when using a paint (solvent paint) that is a mixture of an organic solvent and a pigment (which may contain metal powder or metal flakes), a cleaning liquid whose main component is an organic solvent is used, and when using a paint (water-based paint) that uses water and a pigment (which may contain metal powder or metal flakes), a cleaning liquid whose main component is water is used. Compressed air (hereinafter simply referred to as “air”) is also used during cleaning, but the cleaning liquid used is not limited to the above and can be changed in various ways.

The first switching valve 81 is connected to the downstream end of the flow path 48b that is connected to the downstream side of the first three-way valve 65. The first switching valve 81 has four valve sections 81a, 81b, 81c, and 81E, and can switch the flow paths of liquid (paint, cleaning liquid) and gas (air used during cleaning) depending on the open/closed state of these valve sections 81a, 81b, 81c, and 81E.

The valve 81a is connected to the flow path 48b, and the valve 81b is connected to the flow path 48c. Therefore, when the paint is supplied from the paint tank 46 to the paint head 47 or when the paint is circulating, the valves 81a and 81b are opened and the paint flows from the flow path 48b toward the flow path 48c.

The valve 81c is also connected to the cleaning tank 75. Therefore, during cleaning, when either the valve 81a or the valve 81b described above and the valve 81c are opened, the cleaning liquid supplied from the cleaning tank 75 flows through the open valve portion into the flow path connected to that valve portion.

The valve 81E is connected to a valve 82E of a sixth switching valve 82, which is disposed in the return flow path 49 and will be described later. Therefore, when the valve 81a and the valve 81E are opened, the flow path 48b is connected to the second bypass flow path 53 as a bypass flow path, and the paint in the flow path 48b can be made to flow into the second bypass flow path 53.

The second switching valve 66 is connected to the downstream end of the flow path 48c that is connected to the valve 81b of the first switching valve 81. The second switching valve 66, like the first switching valve 81, has four valve parts 66a, 66b, 66c, and 66d.

The valve 66a is connected to the flow path 48c, and the valve 66b is connected to the flow path 48d. Therefore, when the paint is supplied from the paint tank 46 to the paint head 47 or when the paint is circulating, the valves 66a and 66b are opened and the paint flows from the flow path 48c toward the flow path 48d.

The valve 66c is also connected to the cleaning tank 75. Therefore, during cleaning, when either the valve 66a or the valve 66b described above and the valve 66c are opened, the cleaning liquid supplied from the cleaning tank 75 flows through the opened valve portion into the flow path connected to that valve portion.

The valve 66d is also connected to the drain tank 76. Therefore, during cleaning, when either the valve 66a or the valve 66b described above and the valve 66d are opened, the cleaning liquid and air that have flowed through the flow path connected to the opened valve portion flow into the drain tank 76 via the valve 66d.

The removal filter 62 is connected to the downstream end of the flow path 48d that is connected to the valve 66b of the second switching valve 66. The removal filter 62 is installed in a location where the operation of the painting robot 11 does not affect the removal performance of the removal filter 62, such as the leg 21 of the painting robot 11 or the floor surface of the painting line.

The removal filter 62 removes foreign matter such as coarse foreign matter and pigment agglomerates contained in the paint flowing through the supply path 48, as well as air bubbles contained in the paint that exceed a predetermined size. The removal filter 62 is a mesh-like body such as a wire mesh or a resin net, a porous body, or a metal plate with fine through holes. Examples of the mesh-like body that can be used include metal mesh filters, metal fibers, thin metal wires such as SUS (Steel Use Stainless) formed into a felt shape, compressed and sintered metal filters, electroforming metal filters, electron beam processed metal filters, and laser beam processed metal filters.

The third switching valve 67 is connected to the downstream end of the flow path 48e that is connected to the downstream side of the removal filter 62. Similar to the second selector valve 66, the third selector valve 67 has four valve portions 67a, 67b, 67c, and 67d.

The valve 67a is connected to the flow path 48e, and the valve 67b is connected to the flow path 48f1. Therefore, when the paint is supplied from the paint tank 46 to the painting head 47 or when the paint is circulating, the valves 67a and 67b are opened and the paint flows from the flow path 48e toward the flow path 48f1.

The valve 67c is also connected to the cleaning tank 75. Therefore, for example, during cleaning, when either the valve 67a or the valve 67b described above and the valve 67c are opened, the cleaning liquid supplied from the cleaning tank 75 flows through the opened valve into the flow path connected to that valve portion.

The valve 67d is also connected to the drain tank 76. Therefore, for example, during cleaning, when either the valve 67a or the valve 67b described above and the valve 67d are opened, the cleaning liquid and air that have flowed through the flow path connected to the open valve flow into the drain tank 76 via the valve 67d.

The first gear pump 61 is disposed inside the second rotation arm 28 of the robot arm 23. However, the first gear pump 61 may be disposed at a location other than inside the second rotation arm 28. The first gear pump 61 draws in the paint stored in the paint tank 46 and pumps the paint toward the paint head 47. Therefore, the pressure inside the flow path on the upstream side of the first gear pump 61, that is, between the paint tank 46 and the first gear pump 61 becomes negative pressure, and the paint stored in the paint tank 46 is drawn into the flow path. After that, it is pumped from the first gear pump 61 to the flow path 48f2 connected to the downstream side of the first gear pump 61.

The pressure gauge PS is connected to the flow path 48f2 on the downstream side of the first gear pump 61. The pressure gauge PS measures the pressure of the paint in the flow path 48f2 that is pumped by the first gear pump 61. The drive of the first gear pump 61 is controlled so that the pressure detected by the pressure gauge PS is constant. Note that the pressure gauge PS described above is arranged in the flow path 48f2 on the upstream side of the degassing module 63, but instead of arranging the pressure gauge PS in the flow path 48f2, the pressure gauge PS is placed in the flow path 48g on the downstream side of the degassing module 63. It is also possible to arrange it in both the flow path 48f2 and the flow path 48g. The pressure gauge PS may be disposed in at least one of the flow path 48d on the upstream side of the removal filter 62 and the flow path 48e on the downstream side thereof.

The degassing module 63 is connected to the downstream end of the flow path 48f2 that is connected to the downstream side of the first gear pump 61. The degassing module 63 is installed in a location where the operation of the painting robot 11 does not affect the degassing performance of the degassing module 63, such as the leg 21 of the painting robot 11 or the floor surface of the painting line. The degassing module 63 removes (degasses) dissolved gas and air bubbles from the paint. The degassing module 63 may be, for example, a hollow fiber membrane bundle in which a plurality of hollow fiber membranes are bundled together.

The fourth switching valve 68 is connected to the downstream side of the flow path 48g that is connected to the downstream side of the degassing module 63. The fourth switching valve 68 has six valves 68a, 68b, 68c1, 68c2, 68d1, and 68d2.

The valve 68a is connected to a flow path 48g, and the valve 68b is connected to the flow path 48h. Therefore, when the paint is supplied from the paint tank 46 to the paint head 47 or when the paint is circulating, the valves 68a and 68b are opened and the paint flows from the flow path 48g toward the flow path 48h.

Furthermore, the valve 68a is also connected to the valve 68d2, independently of the valves 68b, 68c1, and 68d1. Therefore, when the valve 68c1 or 68d1 and the valve 68b are opened and the cleaning liquid or paint is flowing through the open valve portion, the valve 68a can be connected to the valve 68d2 independently of that flow.

In addition, the valve 68c1 is connected to the cleaning tank 75. Therefore, during cleaning, when either the valve 68a or the valve 68b described above and the valve 68c1 are opened, the cleaning liquid supplied from the cleaning tank 75 flows through the opened valve portion into the flow path connected to that valve portion.

Furthermore, the valve 68d1 is connected to the drain tank 76. Therefore, during cleaning, when either the valve 68a or the valve 68b described above and the valve 68d1 are opened, the cleaning liquid and air that have flowed through the flow path connected to the open valve portion flow into the drain tank 76 via the valve 68d1.

In addition, the valve 68c2 is connected to the cleaning tank 75. The flow path of the valve 68c2 is not connected to the valves 68b, 68c1, and 68d1, but is connected only to the valves 68a and 68d2. When the valve 68c2 and the valve 68d2 are opened, the cleaning liquid supplied from the cleaning tank 75 flows into the drain tank 76 via the open valve 68d2.

Furthermore, the valve 68d2 is connected to the valves 68a and 68c2 and the drain tank 76. The flow path of the valve 68d2 is not connected to the valves 68b, 68c1, and 68d1, but is connected to the valve 68a and the valve 68c2. When the valve 68a and the valve 68d2 are opened, the paint in the flow path 48g flows into the drain tank 76 via the valve 68a and the valve 68d2. When the valve 68c2 and the valve 68d2 are opened, the cleaning liquid supplied from the cleaning tank 75 flows into the drain tank 76 through the open valve 68d2.

The second three-way valve 69 is connected to the downstream end of the flow path 48h that is connected to the valve 68b of the fourth switching valve 68. The second three-way valve 69 maintains a state in which the flow path 48h communicates with the flow path 48i connected to the paint head 47 on the downstream side when the paint head 47 is painting the vehicle body FR. When the paint head 47 is not painting the vehicle body FR, the second three-way valve 69 is switched to a state in which the flow path 48h communicates with the first bypass flow path 50, which will be described later.

The paint head 47 is at the downstream end of the flow path 48i and is connected to the upstream end of the flow path 49a of the return flow path 49. That is, the paint head 47 is disposed between the downstream end of the supply path 48 and the upstream end of the return flow path 49. The paint head 47 sprays the paint supplied from the supply path 48 onto the vehicle body FR to perform painting. Excess paint that has not been used in painting by the paint head 47 flows back to the paint tank 46 via the return flow path 49.

The first bypass flow path 50 connects the second three-way valve 69 to the third three-way valve 70 (described later), and causes the paint supplied from the supply path 48 to bypass the paint head 47 and return to the return flow path 49 when painting is not being performed by the paint head 47.

### (Return Path)

The return flow path 49 is a flow path that carries the paint that has not been used by the paint head 47 or the paint circulating through the paint circulation path 41 toward the downstream side of the return flow path 49, which is the upstream of the supply path 48, and returns it to the paint tank 46. The return flow path 49 is divided into sections 49a, 49b, 49c, 49d1, 49d2, and 49e by a plurality of components interposed in the return flow path 49. The paint in the return flow path 49 is pumped by the second gear pump 72 (described later) that is disposed midway through the return flow path 49.

The return flow path 49 has, in order from the upstream side, a third three-way valve 70, a fifth switching valve 71 as an outlet side switching valve, a second gear pump 72 as a pump, a sixth switching valve 82 as a downstream side switching valve, and a fourth three-way valve 73.

The third three-way valve 70 is connected to the downstream end of the flow path 49a. The third three-way valve 70 maintains communication between the flow path 49a and the flow path 49b connected to the valve 71a of the fifth switching valve 71, which will be described later, on the downstream side when painting the vehicle body FR by the paint head 47. Furthermore, when the paint head 47 is not painting the vehicle body FR, the third three-way valve 70 is switched to a state in which the first bypass flow path 50 communicates with the flow path 49b.

The fifth switching valve 71 is connected to the downstream end of the flow path 49b that is connected to the downstream side of the third three-way valve 70. The fifth switching valve 71 has six valves 71a, 71b, 71c1, 71c2, 71d1, and 71d2.

The valve 71a is connected to the flow path 49b, and the valve portion 71b is connected to the flow path 49c. Therefore, when the paint is supplied from the paint tank 46 to the paint head 47 or when the paint is circulating, the valves 71a and 71b are opened and the paint flows from the flow path 49b toward the flow path 49c.

Furthermore, the valve 71b is also connected to the valve 71d2, independently of the valves 71a, 71c1, and 71d1. Therefore, when the valve 71c1 or 71d1 and valve 71a are opened and the cleaning liquid or the paint is flowing through the open valve portion, the valve 71b can be connected to the valve 71d2 independently of that flow.

In addition, the valve 71c1 is connected to the cleaning tank 75. Therefore, during cleaning, when either the valve 71a or the valve 71b described above and the valve 71c1 are opened, the cleaning liquid supplied from the cleaning tank 75 flows through the opened valve portion into the flow path connected to that valve portion.

Furthermore, the valve 71d1 is connected to the drain tank 76. Therefore, during cleaning, when either the valve 71a or the valve 71b described above and the valve 71d1 are opened, the cleaning liquid and air that have flowed through the flow path connected to the open valve portion flow into the drain tank 76 via the valve 71d1.

In addition, the valve 71c2 is connected to the cleaning tank 75. The flow path of the valve 71c2 is not connected to the valves 71a, 71c1, and 71d1, but is connected only to the valves 71b and 71d2. When the valve 71c2 and the valve 71d2 are opened, the cleaning liquid supplied from the cleaning tank 75 flows into the drain tank 76 via the open valve 71d2.

Furthermore, the valve 71d2 is connected to the valves 71b and 71c2 and the drain tank 76. The flow path of the valve 71d2 is not connected to the valves 71a, 71c1, and 71d1, but is connected to the valve 71b and the valve 71c2. When the valve 71b and the valve 71d2 are opened, the paint in the flow path 49c flows into the drain tank 76 via the valve 71b and the valve 71d2. When the valve 71c2 and the valve 71d2 are opened, the cleaning liquid supplied from the cleaning tank 75 flows into the drain tank 76 through the open valve 71d2.

The second gear pump 72 is connected to the downstream end of the flow path 49c. The second gear pump 72 is disposed inside the second rotation arm 28 of the robot arm 23. However, the second gear pump 72 may be located at a location other than inside the second rotation arm 28. The second gear pump 72 draws in the paint flowing through the flow path 49c and pumps it to the flow path 49d1 that is connected to the downstream side of the second gear pump 72. In addition, the second gear pump 72 is reversible. In this case, the second gear pump 72 draws in the paint flowing through the flow path 49d1 connected to the downstream side of the second gear pump 72, and pumps it to the flow path 49c connected to the upstream side of the second gear pump 72.

The sixth switching valve 82 is connected to the downstream end of the flow path 49d1 that is connected to the downstream side of the second gear pump 72. The sixth switching valve 82 has four valves 82a, 82b, 82d, and 82E, and can switch the flow paths of liquid (paint, cleaning liquid) and gas (air used during cleaning) depending on the open/closed state of these valves 82a, 82b, 82d, and 82E.

The valve 82a is connected to the flow path 49d1, and the valve 82b is connected to the flow path 49d2. Therefore, when the paint is supplied from the paint tank 46 to the paint head 47 or when the paint is circulating, the valve 82a and the valve 82b are opened and the paint flows from the flow path 49d1 toward the flow path 49d2.

The valve 82d is also connected to the drain tank 76. Therefore, during cleaning, when either the valve 82a or the valve 82b described above and the valve 82d are opened, the cleaning liquid and air that have flowed through the flow path connected to the opened valve portion flow into the drain tank 76 via the valve 82d.

Further, the valve 82E is connected to a valve 81E of the first switching valve 81 provided in the supply path 48. Therefore, when the valves 81a and 81E of the first switching valve 81 are opened and the valves 82E and 82b of the sixth switching valve 82 are opened, the second bypass flow path 53 connecting the valves 81E and 82E is opened. As a result, a circulation path is formed in which the paint circulates through the paint tank 46, the first switching valve 81, the second bypass flow path 53, and the sixth switching valve 82 in this order.

The fourth three-way valve 73 is connected to the downstream end of the flow path 49b. The fourth three-way valve 73 switches between one of two states: a state in which the flow path 49d2 communicates with the flow path 49e connected to the paint tank 46, and a state in which the flow path 49d2 communicates with the drain tank 76. The fourth three-way valve 73 is maintained in a state in which the flow path 49d2 communicates with the flow path 49e when the paint head 47 is painting the vehicle body FR or when paint is circulating. During cleaning, the fourth three-way valve 73 switches to a state in which the flow path 49d2 communicates with the drain tank 76. As a result, the cleaning liquid and air flowing through the flow path 49d2 are discharged into the drain tank 76 via the fourth three-way valve 73.

### [Cleaning and Paint Filling Process]

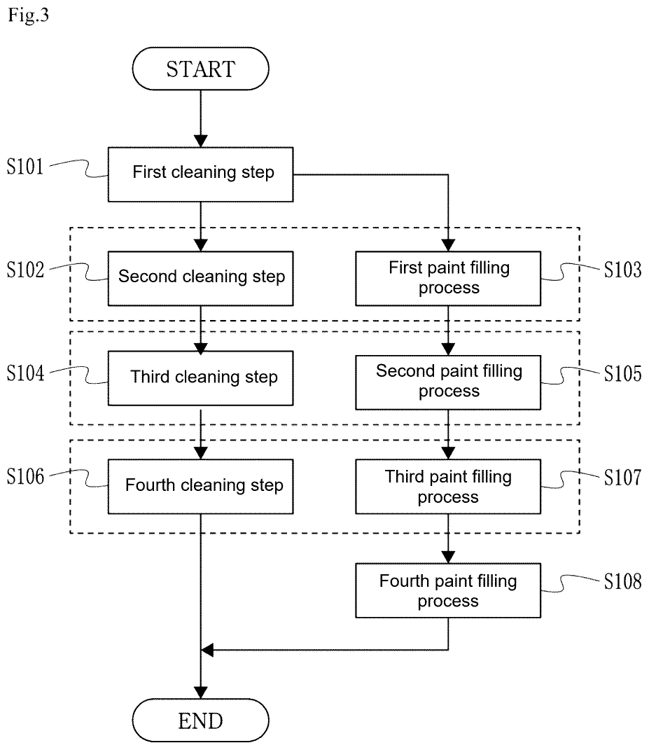

Next, the cleaning process and the paint refilling process for the paint circulation path 41 will be described with reference to FIGS. 2 and 3. FIG. 3 is a flow chart showing the flow of a paint circulation path 41 cleaning process and a paint refilling process of the painting device 10 according to this embodiment.

In the paint circulation path 41, the cleaning section is divided into a plurality of sections. The cleaning process is carried out for each divided section of the supply path 48, successively from the upstream side to the downstream side. In the paint refilling process, the paint is sequentially refilled into the sections that have been cleaned in the cleaning process after cleaning.

The cleaning sections in the paint circulation path 41 include the first section S1, the second section S2, the third section S3 as an upstream section, the fourth section S4 as a downstream section, and the head section HS.

The first section S1 is a section from the first three-way valve 65 through the first switching valve 81 to the second switching valve 66. The second section S2 is a section extending from the second switching valve 66 through the removal filter 62 to the third switching valve 67. The third section S3 is a section extending from the third switching valve 67 through the first gear pump 61 and the degassing module 63 to the fourth switching valve 68. The head section HS is a section extending from the fourth switching valve 68 through the paint head 47 and the first bypass flow path 50 to the fifth switching valve 71. The fourth section S4 is a section from the fifth switching valve 71 through the second gear pump 72 to the sixth switching valve 82.

The cleaning process and paint refilling process in each section will be described below.

The cleaning in each section is carried out by flowing the cleaning liquid and then air once or a plurality of times. The time and number of times for which the cleaning liquid or air is flowed are set appropriately. In addition, the opening of the passages for introducing cleaning liquid and air into each section and the opening of the passages for discharging cleaning liquid and air into the drain tank 76 may be performed simultaneously, or the opening of the passage for discharging may be delayed by a predetermined time.

### (First Cleaning Process)

First, the first cleaning step (S101) is performed. The first cleaning step (S101) is a step of simultaneously performing cleaning of the first section S1 and cleaning of the fourth section S4.

When cleaning the first section S1, the first switching valve 81 opens the valves 81a and 81b, the second switching valve 66 opens the valves 66a and 66c, and the first three-way valve 65 maintains a state in which the flow path 48b and the drain tank 76 are in communication with each other.

As a result, the cleaning liquid and air are supplied from the valve 66c of the second switching valve 66 to the first section S1, and flow up to the first three-way valve 65. The cleaning liquid and air flow in the direction opposite to the paint supply direction when the painting robot 11 paints the vehicle body FR, and are then discharged into the drain tank 76 via the first three-way valve 65.

Alternatively, the first switching valve 81 may be maintained in a state in which the valves 81a and 81c are open and the first three-way valve 65 communicates between the flow path 48b and the drain tank 76. In this case, the flow path 48c is not cleaned, but the first three-way valve 65 is cleaned.

Furthermore, the first switching valve 81 may open the valves 81b and 81c, and the second switching valve 66 may open the valves 66a and 66d. In this case, the first three-way valve 65 is not cleaned, but the flow path 48c is cleaned. By combining these cleaning methods, it is possible to improve the cleaning properties of the first three-way valve 65 and the flow paths.

On the other hand, when cleaning the fourth section S4, the fifth switching valve 71 opens the valves 71b and 71c1, the sixth switching valve 82 opens the valves 82a and 82b, and the fourth three-way valve 73 is maintained in a state in which it connects the flow path 49d2 with the drain tank 76.

As a result, the cleaning liquid and air are supplied from the valve 71c1 of the fifth switching valve 71 to the fourth section S4, and flow up to the fourth three-way valve 73. The cleaning liquid and air flow in the same direction as the paint is supplied when the vehicle body FR is painted, and then are discharged into the drain tank 76 via the fourth three-way valve 73.

Alternatively, the sixth switching valve 82 may open the valves 82a and 82d, and the fifth switching valve 71 may open the valves 71b and 71c1. In this case, the flow path 49d2 is not cleaned, but the flow paths 49c and 49d1 are cleaned.

### (Second Cleaning Process/First Paint Filling Process)

Next, the second cleaning step (S102) is carried out and at the same time the first paint filling step (S103) is carried out. The second cleaning step (S102) is a step of cleaning the second section S2. The first paint filling step (S103) is a step of filling the flow path including the paint tank 46 with paint.

In the second cleaning step (S102), the second switching valve 66 opens the valves 66b and 66d, and the third switching valve 67 opens the valves 67a and 67c.

As a result, the cleaning liquid and air are supplied from the valve 67c of the third switching valve 67 to the second section S2 including the removal filter 62, flow in the opposite direction to the paint supply direction when the vehicle body FR is painted, and then discharged into the drain tank 76 via the valve 66d of the second switching valve 66.

In addition, the second switching valve 66 may open the valves 66b and 66c, and the third switching valve 67 may open the valves 67a and 67d.

In this case, the cleaning liquid and air are supplied to the second section S2 from the valve 66c of the second switching valve 66, flow in the same direction as the paint supply direction when painting the vehicle body FR, and then discharged into the drain tank 76 via the valve 67d of the third switching valve 67.

In the first paint filling step (S103), the first switching valve 81 opens the valves 81a and 81E, and the sixth switching valve 82 opens the valves 82b and 82E. The first three-way valve 65 is held in a state in which the flow paths 48b and 48a communicate with each other, and the fourth three-way valve 73 is held in a state in which the flow paths 49d2 and 49e communicate with each other.

As a result, the paint in the paint tank 46 flows back from the flow path 48a through the first three-way valve 65, the first switching valve 81, the second bypass flow path 53, the sixth switching valve 82 and the fourth three-way valve 73 to the paint tank 46. In this first paint refilling step (S103), the paint is refilled into the paint circulation path that bypasses the supply path 48 and the return path 49.

### (Third Cleaning Process/Second Paint Filling Process)

Next, the third cleaning step (S104) is carried out and at the same time the second paint filling step (S105) is carried out. The third cleaning step (S104) is a step of performing cleaning in the third section S3. The second paint filling step (S105) is a step of filling the first section S1 with paint.

In the third cleaning step (S104), the third switching valve 67 opens the valves 67b and 67d, and the fourth switching valve 68 opens the valves 68a and 68c1.

As a result, the cleaning liquid and air are supplied from the valve 68c1 of the fourth switching valve 68 to the third section S3 including the degassing module 63, flow in the opposite direction to the paint supply direction when the vehicle body FR is painted, and then discharged into the drain tank 76 via the valve 67d of the third switching valve 67.

In addition, the third switching valve 67 may open the valves 67b and 67c, and the fourth switching valve 68 may open the valves 68a and 68d1.

In this case, the cleaning liquid and air are supplied to the third section S3 from the valve 67c of the third switching valve 67, flow in the same direction as the paint supply direction when painting the vehicle body FR, and then are discharged into the drain tank 76 via the valve 68d1 of the fourth switching valve 68.

In the second paint filling step (S105), the first switching valve 81 opens the valves 81a and 81b, and the second switching valve 66 opens the valves 66a and 66d.

As a result, the paint is supplied from the valve 81b of the first switching valve 81 to the first section S1, flows in the same direction as the paint is supplied when painting the vehicle body FR, and then reaches the valve 66a of the second switching valve 66. The valve 66d discharges air pushed out from the flow path 48c when the paint is supplied from the valve 81b, and when a sufficient amount of paint is supplied to the valve 66a, the second switching valve 66 closes the valve 66d. Therefore, the paint is filled in the flow path 48c, and the paint is filled from the paint tank 46 up to the second switching valve 66 of the supply path 48.

Unlike the valve 68d1, the cleaning liquid does not flow through the valve 68d2 of the fourth switching valve 68 regardless of the process. Therefore, after the second paint refilling step (S105) is completed, the fourth switching valve 68 may open the valves 68c2 and 68d2 to allow the cleaning liquid to flow from the valve 68c2 to the valve 68d2 to clean the valve 68d2. The cleaning liquid used for cleaning is discharged from the valve 68d2 to the drain tank 76.

### (Fourth Cleaning Process/Third Paint Filling Process)

Next, the fourth cleaning step (S106) is carried out and at the same time the third paint filling step (S107) is carried out. The fourth cleaning step (S106) is a step of cleaning the head section HS. The third paint filling step (S107) is a step of filling the second and third sections S2, S3 with paint and filling the fourth section S4 with paint.

The head section HS includes the paint head 47 and the first bypass flow path 50, and cleaning of the head section HS is performed in the order of the first bypass flow path 50, the paint head 47, and the first bypass flow path 50. However, instead of this order, the paint head 47 may be cleaned first, and then the first bypass flow path 50 and the paint head 47 may be cleaned in this order. Furthermore, the first bypass flow path 50 and the paint head 47 may be cleaned any number of times.

In the cleaning the first bypass flow path 50 in the fourth cleaning step (S106), the fourth switching valve 68 opens the valves 68b and 68d1, and the fifth switching valve 71 opens the valves 71a and 71c1. Also, the second three-way valve 69 is maintained in a state in which the flow path 48h communicates with the first bypass flow path 50, and the third three-way valve 70 is maintained in a state in which the flow path 49b communicates with the first bypass flow path 50.

As a result, the cleaning liquid and air are supplied to the head section HS from the valve 71c1 of the fifth switching valve 71, and flow through the first bypass flow path 50 in the direction opposite to the paint supply direction when the vehicle body FR is not being painted. Thereafter, the cleaning liquid and air are discharged into the drain tank 76 via the valve 68d1 of the fourth switching valve 68.

Subsequently, in the fourth cleaning step (S106) for cleaning the paint head 47, the fourth switching valve 68 opens the valves 68b and 68d1, and the fifth switching valve 71 opens the valves 71a and 71c1. In addition, the second three-way valve 69 is maintained in a state in which the flow paths 48h and 48i communicate with each other, and the third three-way valve 70 is maintained in a state in which the flow paths 49a and 49b communicate with each other.

As a result, the cleaning liquid and air are supplied to the head section HS from the valve 71c1 of the fifth switching valve 71, and flow through the paint head 47 in the opposite direction to the paint supply direction when painting the vehicle body FR. Thereafter, the cleaning liquid and air are discharged into the drain tank 76 via the valve 68d1 of the fourth switching valve 68.

Thereafter, in the cleaning the first bypass passage 50 in the fourth cleaning step (S106), the fourth switching valve 68 opens the valves 68b and 68d1, and the fifth switching valve 71 opens the valves 71a and 71c1. Also, the second three-way valve 69 is maintained in a state in which the flow path 48h communicates with the first bypass flow path 50, and the third three-way valve 70 is maintained in a state in which the flow path 49b communicates with the first bypass flow path 50.

As a result, the cleaning liquid and air are supplied to the head section HS from the valve 71c1 of the fifth switching valve 71, and flow through the first bypass flow path 50 in the direction opposite to the paint supply direction when the vehicle body FR is not being painted. Thereafter, the cleaning liquid and air are discharged into the drain tank 76 via the valve 68d1 of the fourth switching valve 68. In the above, the pattern has been described in which the cleaning liquid and air are supplied from valve 71c1 and discharged via the valve 68d1. However, instead of such a pattern, the cleaning liquid and air may be supplied from the valve 68c1 and discharged via the valve 71d1.

In the third paint filling step (S107), the second switching valve 66 opens the valves 66a, 66b, the third switching valve 67 opens the valves 67a and 67b, and the fourth switching valve 68 opens the valves 68a and 68d2.

As a result, the paint flows from the valve 66b of the second switching valve 66 in the same direction as the paint supply direction when the vehicle body FR is painted, and is supplied to the second section S2, and then supplied to the third section S3 via the valves 67a and 67b of the third switching valve 67.

At this time, the valve 68a of the fourth switching valve 68 is connected to the valve 68d2 independently of the valves 68b, 68c1, and 68d1. The valve 68d2 discharges air that is pushed out from the flow paths 48d, 48e, 48f1, 48f2, 48g when the paint is supplied from the valve 66b, and when sufficient paint is supplied to the valve 68a, the fourth switching valve 68 closes the valves 68a and 68d2. Therefore, the paint is filled in the flow paths 48d, 48e, 48f1, 48f2, and 48g, and the paint is filled in the supply path 48 from the second switching valve 66 to the fourth switching valve 68.

In other words, by opening the valves 68b, 68c1 or the valves 68b, 68d1, the fourth switching valve 68 can flow the cleaning liquid into the head section HS to clean it, while opening the valves 68a and 68d2 to fill the second and third sections S3 with paint.

In addition, in the third paint refilling process (S107), simultaneously with the above-mentioned operations, the first switching valve 81 opens the valves 81a and 81E, the sixth switching valve 82 opens the valves 82a and 82E, and the fifth switching valve 71 opens the valves 71b and 71d2. Further, the first three-way valve 65 is maintained in a state in which the flow paths 48a and 48b communicate with each other, and the fourth three-way valve 73 is maintained in a state in which the flow paths 49d2 and 49e communicate with each other. In this state, the second gear pump 72 rotates in the direction opposite to the direction in which it rotates when recovering the paint from the paint head 47 along the return flow path 49 during the painting of the vehicle body FR.

As a result, the paint supplied from the paint tank 46 to the first switching valve 81 reaches the sixth switching valve 82 via the second bypass flow path 53, and flows back through the return flow path 49 from the downstream side to the upstream side as the second gear pump 72 rotates. The valve 71b of the fifth switching valve 71 discharges the air pushed out from the flow path 49c when the paint is supplied from the valve 82a, and when the paint reaches the valve 71b, the fifth switching valve 71 closes the valves 71b and 71d2. Thus, the paint is filled in the flow path 49c.

In other words, the fifth switching valve 71 can open the valves 71a, 71c1 or the valves 71a, 71d1 to flow the cleaning liquid into the head section HS to clean it, while opening the valves 71b, 71d2 to fill the fourth section S4 with paint.

Unlike the valve 71d1, no cleaning liquid flows through the valve 71d2 of the fifth switching valve 71 regardless of the process. Therefore, after the third paint refilling step (S107) is completed, the fifth switching valve 71 may open the valves 71c2 and 71d2 to allow the cleaning liquid to flow from the valve 71c2 to the valve 71d2 to clean the valve 71d2. The cleaning liquid used for cleaning is discharged from the valve 71d2 to the drain tank 76.

When the third paint filling step (S107) described above is completed, the flow paths in all sections of the paint circulation path 41 other than the head section HS are already filled with paint. This allows the paint refilling process to begin immediately when refilling the paint in the head section HS, which takes the longest time to refill, thereby shortening the time required to refill the entire paint circulation path 41 with paint. The refilling of the head section HS with paint is carried out in the fourth paint refilling step (S108) described below.

### (Fourth Paint Filling Process)

Next, the fourth paint refilling step (S108) is carried out. The fourth paint filling step (S108) is a step of filling the head section HS with paint.

In the fourth paint refilling step (S108), the fourth switching valve 68 opens the valves 68a and 68b, and the fifth switching valve 71 opens the valves 71a and 71b. In addition, the second three-way valve 69 is maintained in a state in which the flow paths 48h and 48i communicate with each other, and the third three-way valve 70 is maintained in a state in which the flow paths 49a and 49b communicate with each other.

This allows the paint to flow in the same direction as the paint supply direction when painting the vehicle body FR, and fills the paint from the valve 68b of the fourth switching valve 68, through the second three-way valve 69, the paint head 47, and the third three-way valve 70, up to the valve 71a of the fifth switching valve 71.

Furthermore, the second three-way valve 69 is maintained in a state in which the flow path 48h communicates with the first bypass flow path 50, and the third three-way valve 70 is maintained in a state in which the first bypass flow path 50 communicates with the flow path 49b.

As a result, the paint flows in the same direction as the paint is supplied when painting the vehicle body FR, and the first bypass passage 50 is filled with paint. In addition, when filling the paint head 47 with paint, in order to remove air bubbles from within the paint head 47, the fourth switching valve 68 opens the valves 68a and 68b, and the fifth switching valve 71 opens the valve 71a and the valve 71d1, and a predetermined amount of the paint that was initially filled is discharged into the drain tank 76.

Thereafter, while the valves 68a and 68b of the fourth switching valve 68 are kept open, the valves 71a and 71b of the fifth switching valve 71 may be opened while closing the valve 71d1.

When all the above steps are completed, the flow paths in the paint circulation path 41 are already filled with paint. This makes it possible to reduce the time required for refilling paint compared to the case where the paint is refilled from the upstream side of the paint circulation path 41 only after the completion of cleaning up to the paint head 47.

### Effect

According to the above embodiment, the following effects are achieved.

The painting device 10, which is equipped with a paint head 47 that ejects paint, is composed of a supply path 48 that supplies paint to the coating head 47, a return path 49 that returns the paint not ejected from the paint head 47 to the upstream side of the supply path 48, and the paint head 47 that is equipped with a paint circulation path 41 that is divided into a plurality of sections S1, S2, S3, S4, HS, and the plurality of sections S1, S2, S3, S4, HS are individually cleaned in order from the upstream side of the paint circulation path, and after washing is completed and the next section is being washed, the paint is sequentially filled into the upstream section where washing has been completed.

As a result, when the painting device 10 individually cleans the paint circulation path 41 in sequence starting from the upstream side, it can sequentially supply the paint to the upstream section where the cleaning process has already been completed. Therefore, the time required to fill all of the paint can be reduced compared to the case where all sections S1, S2, S3, S4, and HS are filled with paint all at once after cleaning, and the cycle time can be reduced.

The painting device 10 further includes a fourth switching valve 68 that is interposed in the paint circulation path 41 connecting the head section HS including the paint head 47 and the upstream section S3 adjacent to the upstream side of the head section HS, and fills the upstream section S3 with paint while flowing cleaning liquid for cleaning into the head section HS.

This allows the paint to be filled into the upstream third section S3 while the head section HS is being cleaned, so that the paint can be filled into the upstream third section S3, which is on the opposite side of the fourth switching valve 68 from the paint head 47, while the paint head 47, which takes the longest time to clean, is being cleaned.

Therefore, the paint can be immediately filled into the head section HS where the paint head 47 is provided by simply switching the fourth switching valve 68 when the cleaning of the paint head 47 is finished, so that the cycle time can be significantly shortened.

The painting device 10 further includes a fifth switching valve 71 that is interposed in the paint circulation path 41 connecting the head section HS and the downstream section S4 adjacent to the downstream side of the head section HS, and fills the downstream section S4 with paint while flowing the cleaning liquid for cleaning into the head section HS.

This allows the paint to be filled into the downstream fourth section S4 while the head section HS is being cleaned, so that the paint can be filled into the downstream fourth section S4, which is on the opposite side of the fifth switching valve 71 from the paint head 47, while the paint head 47, which takes the longest time to clean, is being cleaned.

Thereafter, when the head section HS and the fourth section S4 are connected, the paint is mixed without interruption between the fourth section S4 which is already filled with paint. Therefore, the time required to fill the fourth section S4 with paint can be shortened, and the cycle time can be significantly shortened.

The painting device 10 further includes a first switching valve 81 interposed in the supply path 48 on the upstream of the fourth switching valve 68, a sixth switching valve 82 interposed in the return path 49 on the downstream of the fifth switching valve 71, and a second bypass path 53 connecting the first switching valve 81 and the sixth switching valve 82, and during cleaning of the head section HS, the first switching valve 81 and the sixth switching valve 82 are connected via the second bypass path 53, so that the paint in the supply path 48 flows via the second bypass path 53 to the return path 49 and flows back from the sixth switching valve 82 to the fifth switching valve 71.

This allows the paint to be filled not only in the supply path 48 on the opposite side of the head section HS of the fourth switching valve 68, but also in the return path 49 on the opposite side of the head section HS of the fifth switching valve 71, during cleaning of the paint head 47, which takes the longest time to clean.

Therefore, when the fifth switching valve 71 is opened upon completion of the cleaning of the paint head 47, the paint filled in the head section HS is mixed continuously with the paint filled in the return flow path 49, so that the paint can be circulated immediately and the painting process can be carried out without waiting for the paint to be filled into the return flow path 49.

The painting device 10 further includes a second gear pump 72 that is interposed in the return flow path 49 and returns the paint in the return flow path 49 to the upstream side of the supply path 48. During the cleaning of the head section HS, the second gear pump 72 is rotated in reverse to cause the paint to flow back from the sixth switching valve 82 to the fifth switching valve 71.

This makes it possible to backflow the paint from the sixth switching valve 82 to the fifth switching valve 71 by using existing components without providing any special configuration, thereby suppressing any increase in the cost of the painting device 10.

All of the embodiments described above represent preferred specific examples of the present invention. The numerical values, components, the arrangement positions of the components, the order of the connections, and the like shown in the above embodiment are merely examples and are not intended to limit the present invention. Moreover, the figures are not necessarily drawn to scale.

Although the embodiments of the present invention have been described above, the above-mentioned embodiments merely show some of the application examples of the present invention, and it is not intended that the technical scope of the present invention be limited to the specific configurations of the above-mentioned embodiments.

For example, in the above embodiment, specific configurations for switching the first to sixth switching valves 82 and the first to fourth three-way valves 73, driving the first and second gear pumps 72, discharging cleaning liquid from the cleaning tank 75, etc. are omitted, but each may be provided with a controller, and each component may be controlled by driving an actuator or sending an electrical signal based on a control signal from the controller.

In addition, in the above embodiment, the removal filter 62 is disposed in the second section S2, and the degassing module 63 is disposed in the third section S3, but the positions of the removal filter 62 and the degassing module 63 are not limited to this and may be provided in other sections.

### REFERENCE SIGNS LIST

10 Painting device
41 Paint circulation path
47 Paint head
48 Supply path
49 Return flow path
53 Second bypass path (bypass passage)
68 Fourth switching valve (inlet side selector valve)
71 Fifth switching valve (exit side selector valve)
72 Second gear pump (pump)
81 First switching valve (upstream selector valve)
82 Sixth switching valve (downstream selector valve)
S1 First section
S2 Second section (upstream section)
S3 Third section (upstream section)
S4 Fourth section (downstream section)
HS Head section

1. A painting device comprising:
a paint head for ejecting paint;
a supply path that supplies the paint to the paint head;
a return flow path that returns the paint not ejected from the paint head to an upstream side of the supply path and the paint head; and
a paint circulation path that is divided into a plurality of sections,
wherein the plurality of sections being configured to be individually cleaned in order from the upstream side of the paint circulation path, and when cleaning for one of the sections is completed and the next section is to be cleaned, the paint is sequentially filled into the upstream section to where cleaning has been completed.

2. The painting device according to claim 1, further comprising:
an inlet side switching valve interposed in the paint circulation path connecting a head section including the paint head and an upstream section adjacent to the upstream side of the head section,
wherein the inlet side switching valve is configured for filling the upstream section with the paint while flowing the cleaning liquid for cleaning into the head section.

3. The painting device according to claim 2, further comprising:
an outlet-side switching valve disposed in the paint circulation path connecting the head section and a downstream section adjacent to the head section on the downstream side thereof, the outlet-side switching valve configured to fill the downstream section with paint while flowing the cleaning liquid for cleaning into the head section.

4. The painting device according to claim 3, further comprising:
an upstream switching valve interposed in the supply passage upstream of the inlet switching valve; and
a downstream switching valve interposed in the return passage downstream of the outlet switching valve, and a bypass passage connecting the upstream switching valve and the downstream switching valve,
wherein, during the cleaning of the head section, the upstream switching valve and the downstream switching valve are connected via the bypass path, so that paint in the supply path flows into the return path via the bypass path and flows back from the downstream switching valve to the outlet switching valve.

5. The painting device according to claim 4,
wherein a pump is disposed in the return flow path and returns the paint in the return flow path to the upstream side of the supply path,
wherein, during the cleaning of the head section, the pump is rotated in reverse to cause the paint to flow back from the downstream switching valve to the outlet switching valve.
